(19) United States
(12) Patent Application Publication
(10) Pub. No.: US 2015/0252778 A1
(43) Pub. Date: Sep. 10, 2015

(54) WIND TURBINE

(71) Applicant: WOBBEN PROPERTIES GMBH, Aurich (DE)

(72) Inventors: Andree Altmikus, Aurich (DE); Mohammad Kamruzzaman, Aurich (DE)

(21) Appl. No.: 14/435,402

(22) PCT Filed: Oct. 16, 2013
(86) PCT No.: PCT/EP2013/071574

§ 371 Date: Apr. 13, 2015

(30) Foreign Application Priority Data
Oct. 16, 2012 (DE) 10 2012 020 198.2
Apr. 26, 2013 (DE) 10 2013 207 640.1

(51) Int. Cl. F03D 1/06

(52) U.S. Cl. CPC F03D 1/0641

(57) ABSTRACT

There is provided a wind power installation rotor blade comprising a suction side, a pressure side, a region near the root, a rotor blade tip a rotor blade leading edge and a rotor blade trailing edge. The rotor blade further has a plurality of stagnation points along the length of the rotor blade, which together can form a stagnation point line. A plurality of vortex generators is provided in the region of the stagnation point line. The stagnation point line is disposed on the underside (generally referred to as the pressure side) of the rotor blade.

### BACKGROUND

1. Technical Field

The present invention concerns a wind power installation rotor blade.

2. Description of the Related Art

A rotor blade of a wind power installation has a rotor blade root region, a rotor blade tip, a rotor blade leading edge, a rotor blade trailing edge, a suction side and a pressure side. Typically the rotor blade is connected at its rotor blade root region to a hub of a wind power installation. In that way the rotor blades are connected to a rotor of the wind power installation and cause the rotor to rotate if there is sufficient wind. That rotation can be converted into electric power by an electric generator.

The rotor blade is moved by the principle of aerodynamic lift. When wind is incident on a rotor blade air is guided along the blade both above it and also below it. The blade is typically curved in such a way that the air above the blade involves a longer path around the profile and therefore has to flow more quickly than the air along the underside. Therefore a reduced pressure is generated above the blade (suction side) and an increased pressure is generated below the blade (pressure side).

EP 1 944 505 A1 shows a wind power installation rotor blade having a plurality of vortex generators on the suction side of the rotor blade.

EP 2 484 898 A1 describes a wind power installation rotor blade having a plurality of vortex generators. The vortex generators are provided in the region near the rotor blade root.

WO 2013/014080 A2 shows a wind power installation rotor blade having a plurality of vortex generators. In addition that specification describes how a rotor blade can be retro-fitted with the vortex generators. In that case the vortex generators are provided at the suction side of the rotor blade and in the region near the rotor blade root.

WO 2007/140771 A1 shows a rotor blade of a wind power installation having a plurality of vortex generators on the suction side of the rotor blade.

WO 2008/113350 A2 also shows a wind power installation rotor blade having a plurality of vortex generators. The vortex generators are provided on the suction side of the rotor blade.

WO 2006/122547 A1 shows a rotor blade of a wind power installation having a plurality of vortex generators on the suction side of the rotor blade.

WO 2012/082324 A1 shows a wind power installation rotor blade having a plurality of vortex generators, the vortex generators being provided in the region near the rotor blade root.

### BRIEF SUMMARY

Operation of the wind power installation involves sound emission which is to be reduced as much as possible to improve acceptance of wind power installations among the population.

There is provided a wind power installation rotor blade having a suction side, a pressure side, a region near the root, a rotor blade tip, a rotor blade leading edge and a rotor blade trailing edge. The rotor blade further has a plurality of stagnation points along the length of the rotor blade, which together can form a stagnation point line. A plurality of vortex generators is provided in the region of the stagnation point line. The stagnation point line is disposed on the underside (generally referred to as the pressure side) of the rotor blade.

The stagnation point is that point at the surface of the rotor blade, at which the speed of the flow disappears so that kinetic energy can be completely converted into a pressure energy. The position of the stagnation point can be changed by changing the pitch angle. The stagnation point is that point at which the flow divides up, and a part of the flow flows over the suction side of the rotor blade and the other part flows over the pressure side.

According to an aspect of the invention the vortex generators are provided in the longitudinal direction at more than 50%, in particular more than 60% of the length of the rotor blade (that is to say the last 50% to 40% of the rotor blade in the direction of the rotor blade tip are provided with vortex generators in the region of the stagnation point line).

The shape of the vortex generators can be for example a semicircle, oval or arrow-shaped in plan view. The diameter of the vortex generators is less than 100 mm. The spacing between adjacent vortex generators is at least one times the diameter and is at a maximum ten times the diameter of the vortex generators.

The height of the vortex generators is at a maximum one-quarter of the diameter. The 3D shape of the vortex generators can represent a disk of constant thickness or a portion of a sphere of a round basic shape.

Further configurations of the invention are subject-matter of the appendant claims.

### BRIEF DESCRIPTION OF THE SEVERAL VIEWS OF THE DRAWINGS

Advantages and embodiments by way of example of the invention are described in greater detail hereinafter with reference to the drawing.

FIG. 1 shows a diagrammatic view of a wind power installation according to the invention,

FIG. 2 shows a diagrammatic view of a rotor blade according to a first embodiment,

FIG. 3 shows a diagrammatic sectional view of a rotor blade according to a first embodiment,

FIG. 4 shows a perspective view of a portion of a wind power installation rotor blade according to a second embodiment, and

FIG. 5 shows a polar diagram to illustrate a variation in the lift coefficient in relation to the effective angle of incidence for a wind power installation rotor blade.

### DETAILED DESCRIPTION

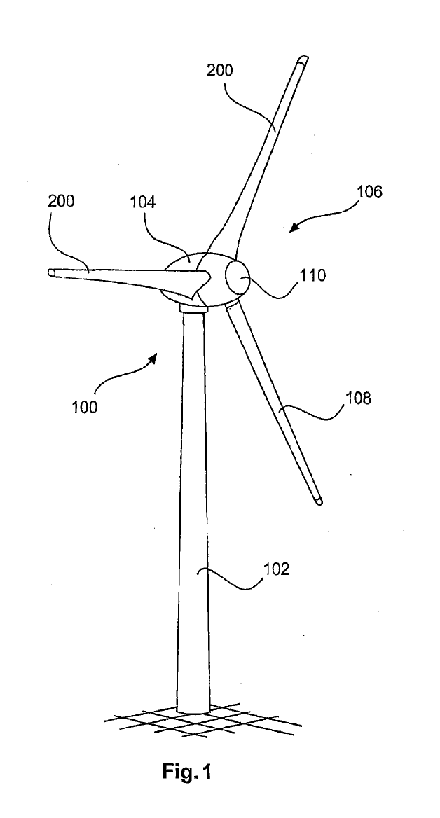

FIG. 1 shows a diagrammatic view of the wind power installation according to one embodiment of the invention. The wind power installation 100 has a pylon 102 and a pod 104. Provided on the pod 104 is a rotor 106 having three rotor blades 200 and a spinner 110. In operation the rotor blade 106 is caused to rotate by the wind and then thereby causes rotation of an electric generator in the pod, which generates electric power from the rotation. The pitch of the rotor blades or the angle of incidence of the rotor blades 200 can be altered by pitch motors at the rotor blade roots of the respective rotor blades 200.

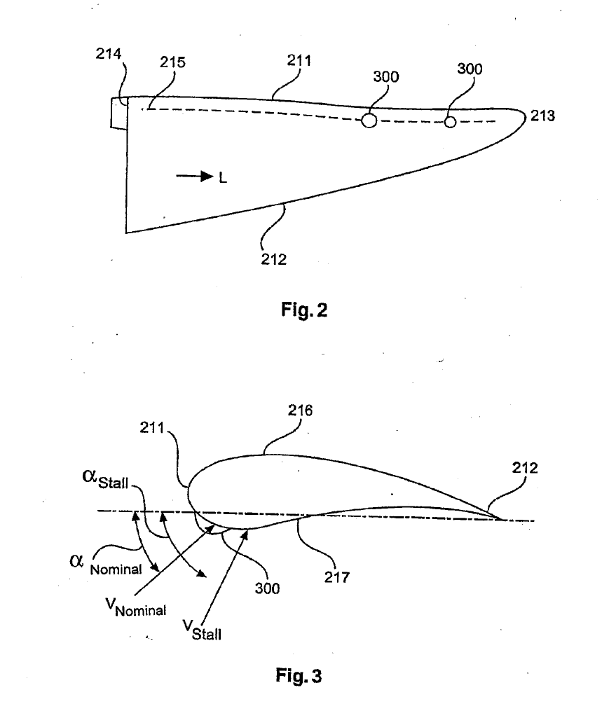

FIG. 2 shows a diagrammatic view of a wind power installation rotor blade according to a first embodiment. The rotor blade 200 has a rotor blade leading edge 211, a rotor blade trailing edge 212, a rotor blade tip 213 and a rotor blade root region 214. The rotor blade further has a longitudinal direction L which extends from the rotor blade root region 214 to the rotor blade tip 213. The rotor blade further has a stagnation point line 215 which extends on the pressure side of the rotor blade. As the cross-section of the rotor blade change in the longitudinal direction L the stagnation point also changes for each portion of the rotor blade. Thus a stagnation point line 215 can be formed from the plurality of stagnation points. A plurality of vortex generators 300 is provided in the region of the stagnation point line 215. The rotor blade 200 is releasably fixed to the rotor 106 of the wind power installation by the rotor blade root region 214. The end of the rotor blade root region 214 which is fixed to the rotor 106, for example to the rotor hub, is of a round configuration and can be releasably fixed to the hub of the rotor 106 by way of a plurality of screw connections.

The vortex generators 300 are provided in the region of the stagnation point line 215 at a predetermined angle of incidence, for example the nominal angle of incidence.

Optionally the vortex generators 300 can be provided as from a length of 50% to 100% of the rotor blade, as from the rotor blade root region 214. In particular the vortex generators 300 can be provided at between 60% and 100% of the length of the rotor blade, as from the rotor blade root region 214.

Due to the provision of the vortex generators in the region of the stagnation points of the rotor blade it is possible to positively influence detachment of the flow at the rotor blade trailing edge.

The vortex generators 300 can be circular, oval or arrow-shaped in plan view. The diameter of the vortex generators is less than 100 mm (for example 20 mm). The spacing between adjacent vortex generators 300 is at least one times the diameter of the vortex generators and at a maximum ten times the diameter of the vortex generators. The height of the vortex generators is at a maximum one-quarter of the diameter of the vortex generators. The three-dimensional shape can correspond to a disk of constant thickness or a portion of a sphere with a round basic shape. An arrow-shaped plan-view outline can represent a pyramid shape. While the orientation in the flow direction is unimportant in the case of a round basic shape the pyramid is oriented with its tip in the flow direction.

FIG. 3 shows a diagrammatic sectional view of a wind power installation rotor blade according to the first embodiment. The rotor blade 200 has a rotor blade leading edge 210, a rotor blade trailing edge 212, a suction side 216 and pressure side 217. The vortex generators 300 are provided in the region of the pressure side 217 and in the region of the stagnation point or the stagnation point line 215.

FIG. 4 shows a perspective view of a portion of a rotor blade according to a second embodiment. In this portion the rotor blade 200 has two vortex generators 300 which are provided in the region of the stagnation point line 215. Optionally the vortex generators 300 can be so provided in the region of the stagnation point line 215 that in nominal operation they are disposed in the region of the stagnation point line. If the effective angle of incidence increases globally or locally due to a changing wind condition (for example with a gusty wind or in operation in shear wind conditions) the stagnation point moves behind the vortex generators and vortex filaments 400 occur at the vortex generators, which stabilize larger detachment regions on the suction side and which thus still provide for a flow in contact and for maintenance of lift, even under disadvantageous afflux flow conditions. FIG. 4 shows the central line 215b between the suction and pressure sides, the stagnation point line 215a with an effective angle of incidence α_{eff} at nominal speed (nominal range) and the stagnation point line 215c at the effective angle of incidence α_{eff} in the stall region.

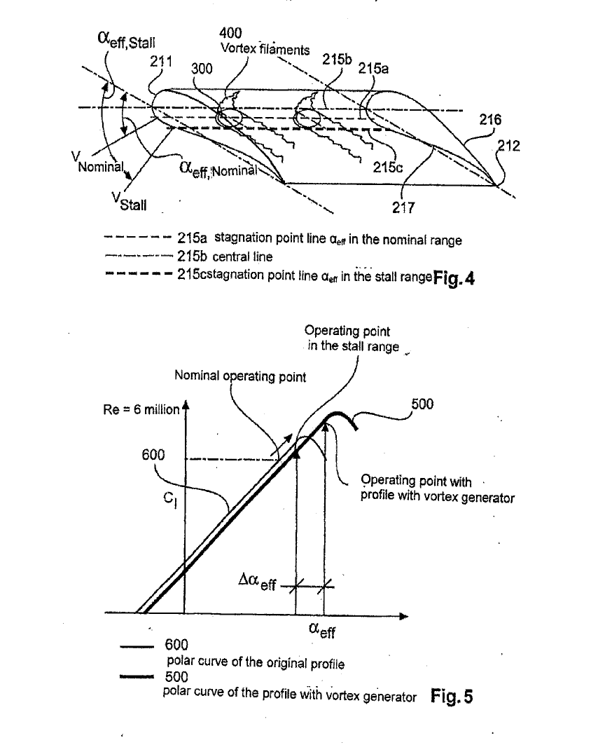

FIG. 5 shows a polar diagram to illustrate the variation in the lift coefficient in relation to the effective angle of incidence or pitch angle at a Reynolds number of 6 million. This shows the variation in the lift coefficient C_{L} in relation to the effective flow angle α_{eff} for a rotor blade without vortex generators 600 and for a rotor blade having vortex generators 500. It can thus be seen from FIG. 5 that the use of the vortex or eddy generators according to the invention leads to a delay in the beginning of detachment of the air flow. The lift coefficient C_{L} is increased, that is to say the rotor blade with the vortex generators according to the invention can achieve a higher lift coefficient and can attain a higher effective angle of incidence α_{eff}. The maximum lift coefficient C_{L} is thus pushed out to higher angles of incidence of the rotor blade. For the wind power installation, in on-going operation, that signifies an improvement in the steady-state detachment characteristics of the profile with at the same time minimization of the negative increase in resistance. That explains the reduction in noise in respect of rotor blades in steady-state afflux flow conditions so that the wind power installation according to the invention provides reduced sound emission.

1. A wind power installation rotor blade comprising:
a rotor blade leading edge, a rotor blade trailing edge, a rotor blade root for connection to a wind power installation, and a rotor blade tip;
a suction side and a pressure side;
a stagnation point line along a longitudinal direction of the rotor blade from the rotor blade root to the rotor blade at a predetermined angle of incidence of the rotor blade, wherein the stagnation point line is on the pressure side; and
a plurality of vortex generators in a region of the stagnation point line.

2. The rotor blade according to claim 1 wherein the region that includes the plurality of vortex generators is greater than 50% of the length of the rotor blade along the longitudinal direction.

3. The rotor blade according to claim 1 wherein each of the plurality of vortex generators has a shape that is circular, oval or arrow-shaped in plan view.

4. The rotor blade according to claim 1 wherein each of the plurality of vortex generators has a diameter that is less than 100 mm.

5. The rotor blade according to claim 1 wherein each of the plurality of vortex generators has a height that corresponds at a maximum to one-quarter of the diameter of the vortex generators.

6. The rotor blade according to claim 1 wherein each of the plurality of vortex generators has a shape that corresponds to a disk of substantially constant thickness or a portion of a sphere with a round basic shape.

7. The rotor blade according to claim 1 wherein a spacing between adjacent vortex generators corresponds to between one and ten times the diameter of the vortex generators.

8. A rotor blade according to claim 1 wherein the predetermined angle of incidence represents the effective angle of incidence in the nominal range.

9. A wind power installation comprising:
at least one wind power installation rotor blade including:
a rotor blade leading edge, a rotor blade trailing edge, a rotor blade root for connection to a wind power installation, and a rotor blade tip;
a suction side and a pressure side;
a stagnation point line on the pressure side and along a longitudinal direction of the rotor blade from the rotor blade root to the rotor blade, wherein the stagnation point line is associated with an particular pitch of the rotor blade; and
a plurality of vortex generators in a region that includes the stagnation point line;

10. The wind power installation according to claim 9 wherein the region that includes the plurality of vortex generators is greater than 50% of the length of the rotor blade along the longitudinal direction.

11. The wind power installation according to claim 9 wherein each of the plurality of vortex generators has a shape that is circular, oval or arrow-shaped in plan view.

12. The wind power installation according to claim 9 wherein each of the plurality of vortex generators has a diameter that is less than 100 mm.

13. The wind power installation according to claim 9 wherein each of the plurality of vortex generators has a height that corresponds at a maximum to one-quarter of the diameter of the vortex generators.

14. The wind power installation according to claim 9 wherein each of the plurality of vortex generators has a shape that corresponds to a disk of substantially constant thickness or a portion of a sphere with a round basic shape.

15. The wind power installation according to claim 9 wherein a spacing between adjacent vortex generators corresponds to between one and ten times the diameter of the plurality of vortex generators.

16. A wind power installation according to claim 9 wherein the pitch of the rotor blade represents the effective angle of incidence in the nominal range.
